(19) United States
(12) Patent Application Publication
(10) Pub. No.: US 2023/0359597 A1
(43) Pub. Date: Nov. 9, 2023

(54) SYSTEM AND METHOD FOR REDUCING DATA INCONSISTENCY AFTER PURGING CLIENT RECORDS, IN FINANCIAL INSTITUTE (FI) DATABASES, WHEN EXCEEDING RETENTION PERIOD

(71) Applicant: Actimize LTD., Ra'anana (IL)

(72) Inventors: Aniruddha BODKHE, Pune (IN); Atul KHARAT, Pune (IN); Nitiket DECHARWAL, Pune (IN); Neha SHARMA, Uttar Pradesh (IN); Jitendra PATIL, Pune (IN); Ritesh GAIDHANE, Pune (IN)

(21) Appl. No.: 17/735,137

(22) Filed: May 3, 2022

(51) Int. Cl. G06F 16/215; G06F 21/62

(52) U.S. Cl. CPC G06F 16/215; G06F 21/6245

(57) ABSTRACT

A computerized-method for reducing data inconsistency after purging client records, in Financial Institute (FI) databases, when exceeding retention period, is provided herein. The computerized-method includes operating a purge-request module. The purge-request module includes a. receiving a file including one or more customer identifications (ID); b. for each client in the received file: (i) retrieving references and links from the one or more customer-information databases to populate one or more tables with customer details based on the customer IDs; (ii) presenting a list of one or more conditions via a Graphical User Interface (GUI) of the application to enable a user to select one or more conditions for validation before purging; (iii) checking each selected condition; (iv) when the selected conditions for validation before purging are met marking the client for batch process purging; and c. purging all marked clients via a batch process.

### TECHNICAL FIELD

The present disclosure relates to the field of reducing data inconsistency after purging client records, in Financial Institute (FI) databases, when exceeding retention period.

### BACKGROUND

General Data Protection Regulation (GDPR) 2016/679, is a regulation on data protection and privacy, addresses transfer of personal data. The GDPR focuses on accountability, transparency, and governance to minimize the risk of breaching and upholding personal data protection by purging inactive client data.

Retention period is the maximum duration in number of days which financial institutions agree to keep client data in the system on any given point of time. Current solution in Financial Institutions (FI) removes inactive clients after the data exceeds retention period but requires to manually load data in source database for purging.

This manual work may lead to data inconsistency due to missed dependent data of the purged clients, which may be overlooked. The current solution doesn't validate that there are no active transactions or transfer from parties before the data of the client is purged. FIs have to manually look up for relations for each client to be purged and populate dozens of database tables. These database tables in turn would be used for purging without any further validation which may result in data inconsistency and inaccurate detection. Accordingly, there is a need for a technical solution to reduce manual efforts by auto-populating the tables and validating the data before purging.

Moreover, when FIs delete individual records from the system, logical entity or party group references may continue to prevail in the system, which may lead to data inconsistency and invalid links. Current solution provides a utility to purge client data from the system based on data loaded in a couple dozen of source database tables. The utility is based on the “right to be forgotten” and “data minimization” key principles which help in data protection and privacy and in turn address the transfer of personal data.

Therefore, there is a need for a technical solution for checking all details before purging the data related to the client and for operating a validation of check points, before sending the client data for purging. Additionally, there is a need for a Graphical User Interface (GUI) to enable receiving instructions for the automate data loading from the FI and to enable the FI to generate reports in a graphical form with relevant statistical details.

### SUMMARY

There is thus provided, in accordance with some embodiments of the present disclosure, a computerized-method for reducing data inconsistency after purging client records, in Financial Institute (FI) databases, when exceeding retention period.

Furthermore, in accordance with some embodiments of the present disclosure, in a computerized system that includes one or more processors, one or more customer-information databases and an application associated thereto, the one or more processors may operate a purge-request module.

Furthermore, in accordance with some embodiments of the present disclosure, the purge-request module may include: a. receiving a file including one or more customer identifications (ID)s: b. for each client in the received file: (i) retrieving references and links from the one or more customer-information databases to populate one or more tables with customer details based on the customer IDs; (ii) presenting a list of one or more conditions via a Graphical User Interface (GUI) of the application to enable a user to select one or more conditions for validation before purging; (iii) checking each selected condition; and (iv) when the selected conditions for validation before purging are met marking the client for batch process purging; c. purging all marked clients via a batch process.

Furthermore, in accordance with some embodiments of the present disclosure, the one or more conditions may be selected from at least one of: (i) no active transactions; (ii) the client is part of a Logical Entity (LE) or a Party Group (PGR); (iii) active primary account of the client is associated with an active party: (iv) open Suspicious Activity Monitoring (SAM) alert for accounts related to the client; and (v) open SAM alert for the client.

Furthermore, in accordance with some embodiments of the present disclosure, the purge-request module may further comprise presenting a progress of each batch process.

Furthermore, in accordance with some embodiments of the present disclosure, the purge-request module may further comprise generating a statistics report for each completed batch process.

Furthermore, in accordance with some embodiments of the present disclosure, the statistic report may be in tabular format or in pie-chart format.

Furthermore, in accordance with some embodiments of the present disclosure, the statistics report in tabular format may include unique sequence number of the batch process. start timestamp, end timestamp, number of records processed, and one or more customers purged.

Furthermore, in accordance with some embodiments of the present disclosure, the statistics report in pie-chart format may include count of related parties, accounts, alerts, number parties purged by the application.

Furthermore, in accordance with some embodiments of the present disclosure, the purge-request module may module may further comprise purging related alerts for accounts related to each marked client, when open SAM alert for accounts related to the client condition has been selected.

Furthermore, in accordance with some embodiments of the present disclosure, the one or more customer-information databases may include at least one of: (i) application database: (ii) landing database; (iii) audit database; (iv) profile database.

Furthermore, in accordance with some embodiments of the present disclosure, the purging of all marked clients via the batch process further includes marking the retrieved references and links which are related to all marked clients as not part of detection and alert distribution process of associated Anti Money Laundering (AML) system.

### BRIEF DESCRIPTION OF THE DRAWINGS

FIG. 1 schematically illustrates a high-level diagram of a system for reducing data inconsistency after purging client records, in Financial Institute (FI) databases, when exceeding retention period, in accordance with some embodiments of the present disclosure;

FIG. 2 is a high-level workflow of a purge-request module, in accordance with some embodiments of the present disclosure;

FIGS. 3A-3C are a high-level workflow of a method for reducing data inconsistency after purging client records, in Financial Institute (FI) databases, when exceeding retention period, in accordance with some embodiments of the present disclosure;

FIG. 4 is a screenshot of statistics report in pie-chart format, in accordance with some embodiments of the present disclosure;

FIG. 5 is a screenshot of a user interface for purging, in accordance with some embodiments of the present disclosure; and

FIG. 6 is a screenshot of a statistics report in tabular format, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art, that the disclosure may be practiced without these specific details. In other instances, well-known methods, procedures. components, modules, units and/or circuits have not been described in detail so as not to obscure the disclosure.

Although embodiments of the disclosure are not limited in this regard, discussions utilizing terms such as, for example, “processing,” “computing” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements. units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “data inconsistency” as used herein refers to having data details not updated in some databases or having references to data that doesn't exist. Purging client data without proper validations can leave behind trailing relations in the system and it can also result with unreliable and meaningless information.

All the Financial Institutions (FI)s are required to adhere by the General Data Protection Regulation (GDPR), thus periodically purging inactive clients from the system.

When FIs delete individual records from the system, logical entity or party group references may continue to prevail in the system which may lead to data inconsistency and invalid links. Current solution provides a utility to purge client data from the system based on data loaded in a couple dozen of source database tables.

According to some embodiments of the current disclosure, to avoid data inconsistency in one or more databases when purging clients data, there is a need for a technical solution for checking all details before purging the data related to the client. For example, checking that there are no active transactions in the system, when the client is part of any Logical Entity (LE) or Party Group (PGR) or if the client active primary account is associated with one party and another alive party in the system, or when there is an open Suspicious Activity Monitoring (SAM) alert for accounts related to the party along with Customer Due Diligence (CDD) and Watch List Filtering (WLF) alerts in the system.

Therefore, there is a need for a technical solution for checking all details related to the client before purging the data and to operate a validation of check points, before sending the client data for purging to prevent data inconsistency.

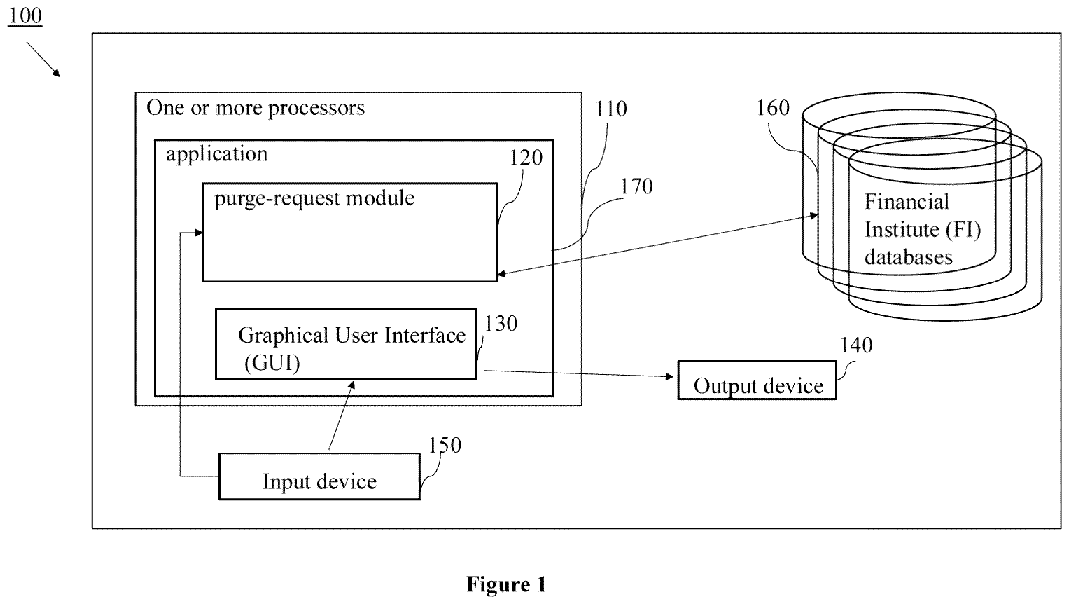

FIG. 1 schematically illustrates a high-level diagram of a system 100 for reducing data inconsistency after purging client records, in Financial Institute (FI) databases, when exceeding retention period, in accordance with some embodiments of the present disclosure.

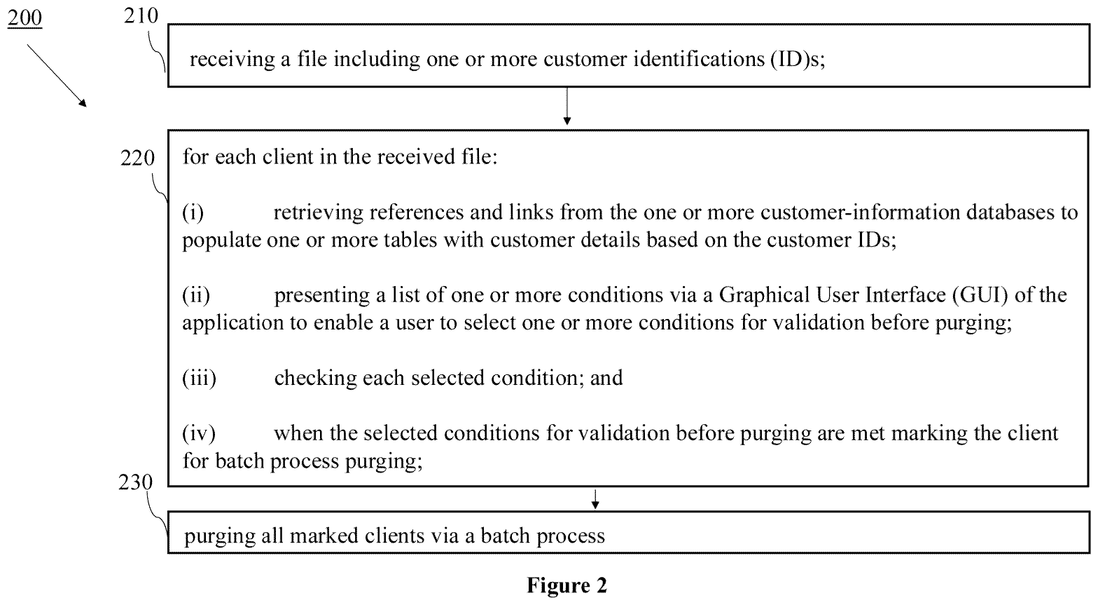

According to some embodiments of the current disclosure, a computerized-system, such as system 100 may include one or more processors 110, one or more customer-information databases 160 and an application 170 associated thereto. The one or more processors 110 may operate a module, such as purge-request module 120 and such as purge-request module 200 in FIG. 2.

According to some embodiments of the current disclosure, the one or more databases may be application database, profile database. and unified data manager database. FIs maintain different types of information in separate databases. For example, profile database is commonly dedicated for maintaining the recent client information and their relations. unified data manager is commonly used as a landing database for storing raw data from Client. Application database may store all rules having thresholds such as, retention period.

According to some embodiments of the current disclosure, the purge-request module 120 may include receiving a file including one or more customer identifications (ID)s for purge from the one or more databases 160 via an input device 150. For example, purging under GDPR.

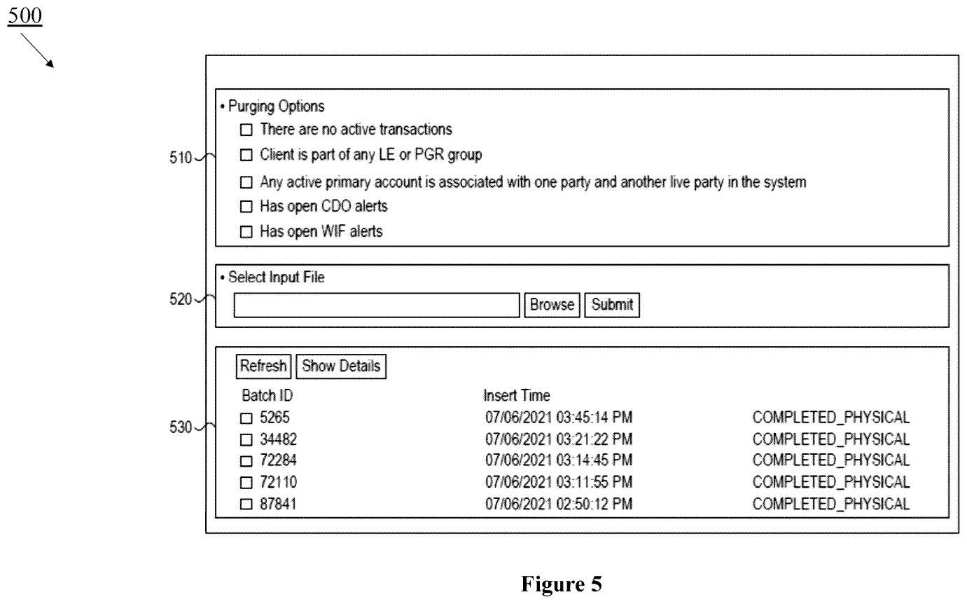

According to some embodiments of the current disclosure, for each client in the received file, the purge-request module 120 may further (i) retrieve references and links from the one or more customer-information databases, such as one or more databases 160 to populate one or more tables with customer details based on the customer IDs; (ii) present a list of one or more conditions via a Graphical User Interface (GUI) such as GUI 130 of the application to enable a user to select one or more conditions for validation before purging, as shown for example, in element 510 in FIG. 5; (iii) check each selected condition; and (iv) when the selected conditions for validation before purging are met, marking the client for batch process purging.

According to some embodiments of the current disclosure, the purge-request module 120 may purge all marked clients via a batch process from the one or more databases 160. The one or more databases may be (i) application database; (ii) landing database: (iii) audit database; (iv) profile database.

According to some embodiments of the current disclosure, the application database may hold settings for retention period set by the Financial Institution the landing database may connect the Financial Institution and the application 120. The audit database may store all the reporting and maintenance data, the tabular view and graphs function on this database. The profile database may hold customer details and customer referential information. All the detections may be carried out based on the data stored in profile database.

According to some embodiments of the current disclosure, a landing database may be the core database where all the customer information may be stored. Based on the input file received from the end users and validations performed by a core logic component, communication may be made with the one or more databases 160 to purge client and its related data from the system.

According to some embodiments of the current disclosure, the core logic may be implemented in Analytics Intelligence Server (AIS) code or any other business intelligence solution that enables companies to analyze data, where all the validations may be performed to check if there are any active transactions available or any related party/account data in the system. It may also check for any open alerts in the system when such a condition has been selected. Only when all the validations return ‘True’ as a result, data would be deleted from FI database 160 and output would be displayed on an application 170 such as a web application, via an associated GUI 130.

According to some embodiments of the current disclosure, the one or more conditions may be selected via the GUI 130 from at least one of: (i) no active transactions; (ii) the client is part of a Logical Entity (LE) or a Party Group (PGR); (iii) active primary account of the client is associated with an active party; (iv) open Suspicious Activity Monitoring (SAM) alert for accounts related to the client; and (v) open SAM alert for the client, as shown for example, in element 510 in FIG. 5.

According to some embodiments of the current disclosure, the auto-populating of the tables and validating the data before purging may reduce manual efforts. Based on the customer IDs for deletion, which may be provided in a file, such as Comma-Separated Values (CSV) file, all references and links may be fetched and populate all required tables in the one or more databases.

According to some embodiments of the current disclosure, based on selected validation points by the FIs via the GUI 130, the related entities and references may be populated in the database tables and checked for any active transaction or alert before proceeding with purging. On successful evaluation of each validation condition, the customer details may be purged from the one or more databases.

According to some embodiments of the current disclosure, in case of validation failure, e.g., presence of active relation, active transaction or open Alert, the customer details may not be purged from the FIs system, e.g., databases.

According to some embodiments of the current disclosure, the application 170 may be associated with an AI-enabled financial crime investigation management platform, may improve decision making and reduce investigation time for a single alert. It may provide a unified platform to manage alerts and cases from a wide ecosystem of financial crime solutions.

According to some embodiments of the current disclosure, a component. such as data processing unit may process the data from the file and may insert it into a database. Once data has been inserted, the database may respond using feedback or status. The data processing unit may fetch all required data from the one or more databases 160 and may invoke the core logic to perform all the checks, e.g., the selected validations.

According to some embodiments of the current disclosure, the references and links may be customer-account relations. customer-customer relations, transactions to/from customer, and the like which may be fetched instead of manually looking for these relations. These relations may be populated in referential tables and validated against selected validation check points.

According to some embodiments of the current disclosure, based on the selected validation points checked which have been entered via the GUI 130, the related entities and references may be populated in the database tables and checked for any active transaction or alert before proceeding with purging.

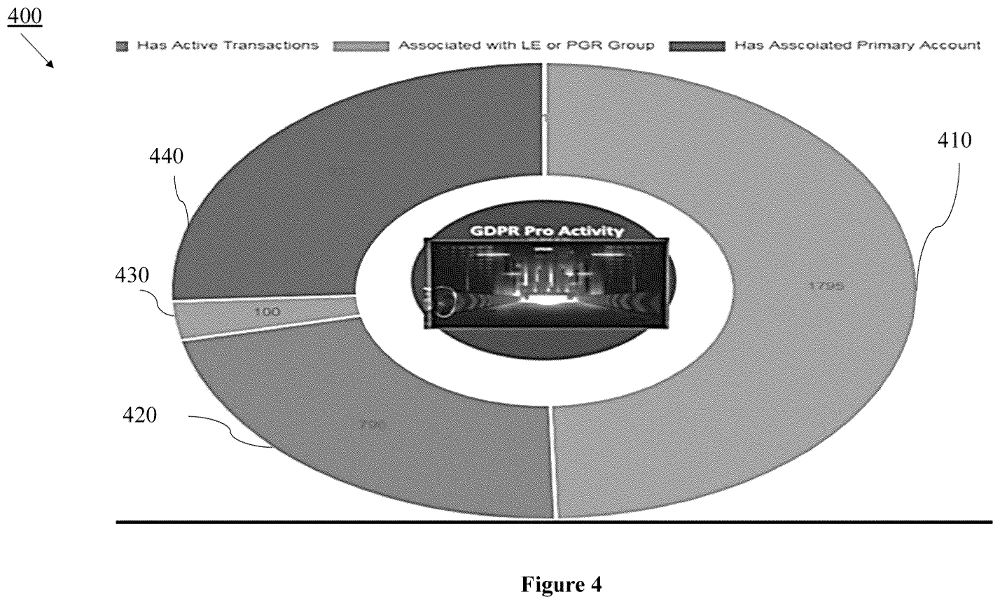

According to some embodiments of the current disclosure, on successful evaluation of each validation condition, the client details may be purged from the databases. The purge-request module 120 may further include presenting a progress of each batch process via the GUI 130. The purge-request module 120 may include generating a statistics report for each completed batch process, in tabular format or in pie-chart format, such as statistics report in pie-chart format 400 in FIG. 4.

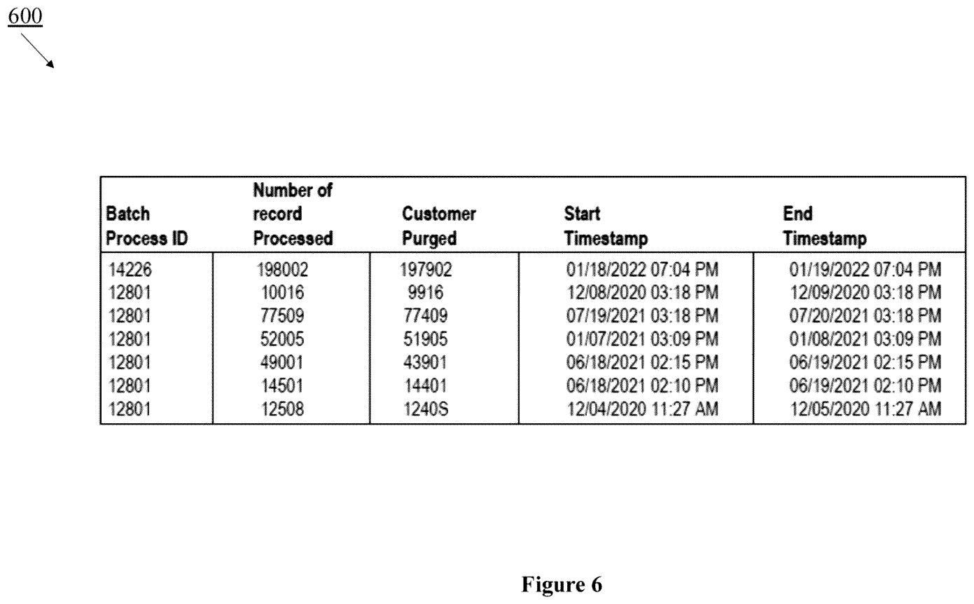

According to some embodiments of the current disclosure, the statistics report in tabular format may include unique sequence number of the batch process. start timestamp, end timestamp, number of records processed, and one or more customers purged. For example, statistics report as shown in table 600 in FIG. 6.

According to some embodiments of the current disclosure, the statistics report in pie-chart format may include count of related parties, accounts. alerts, number parties purged by the application 170.

According to some embodiments of the current disclosure, the purge-request module 120 may include purging related alerts for accounts related to each marked client, when open SAM alert for accounts related to the client condition has been selected.

According to some embodiments of the current disclosure, the purging of all marked clients via the batch process may further include marking the retrieved references and links which are related to all marked clients as not part of detection and alert distribution process of associated Anti Money Laundering (AML) system.

According to some embodiments of the current disclosure, the purge-request module 120 may operate audit maintenance by recording all the details of purging of customers which have been flagged in the databases. Additionally, it may capture the reasoning for the customers which are not purge for a given batch. The graphs may be generated based on this audit information.

FIG. 2 is a high-level workflow of a purge-request module 200, in accordance with some embodiments of the present disclosure.

According to some embodiments of the current disclosure, operation 210 may comprise receiving a file including one or more customer identifications (ID)s. The received file may be a CSV format or any other file format. The customers IDs may be for deletion under GDPR.

According to some embodiments of the current disclosure, operation 220 may comprise for each client in the received file: (i) retrieving references and links from the one or more customer-information databases to populate one or more tables with customer details based on the customer IDs: (ii) presenting a list of one or more conditions via a Graphical User Interface (GUI) of the application to enable a user to select one or more conditions for validation before purging: (iii) checking each selected condition; and (iv) when the selected conditions for validation before purging are met marking the client for batch process purging.

According to some embodiments of the current disclosure, operation 230 may comprise purging all marked clients via a batch process.

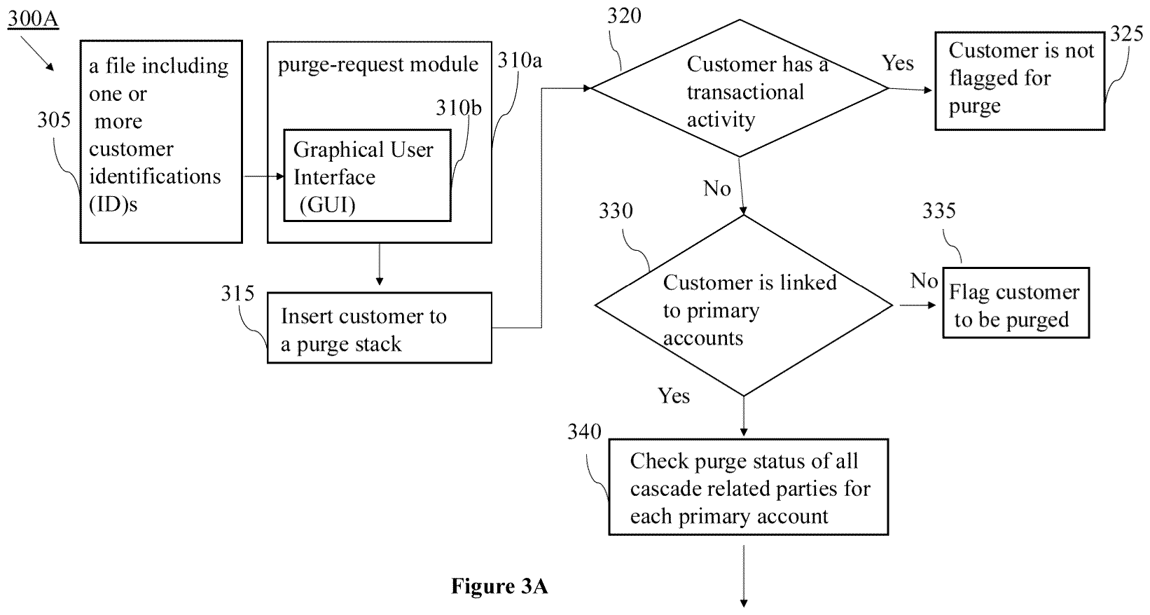

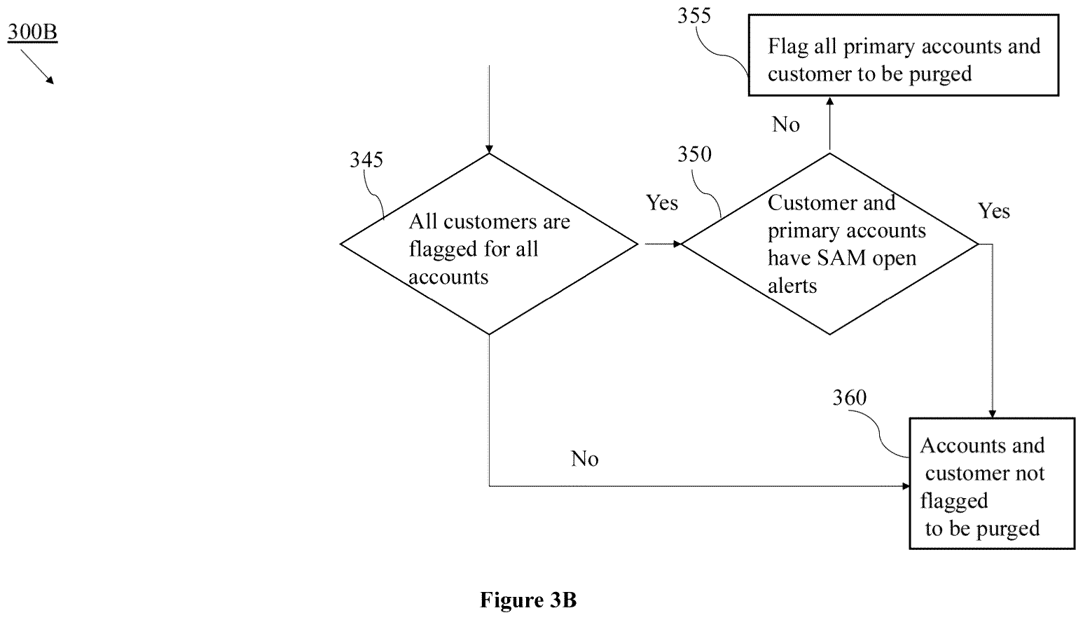

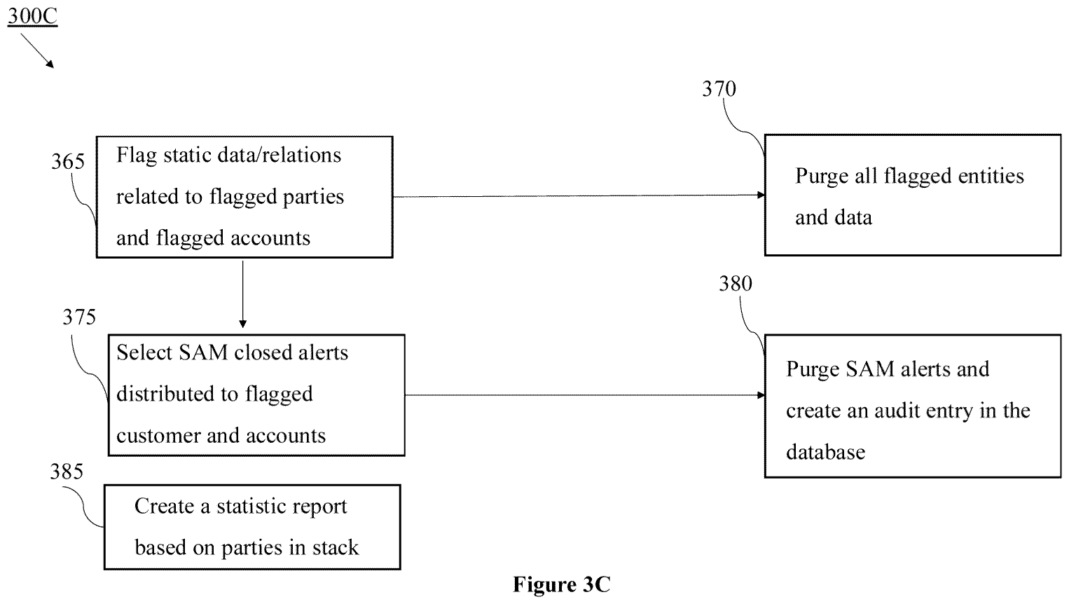

FIGS. 3A-3C are a high-level workflow of a method for reducing data inconsistency after purging client records, in Financial Institute (FI) databases, when exceeding retention period, in accordance with some embodiments of the present disclosure.

According to some embodiments of the current disclosure, a file including one or more customer identifications (ID)s 305 may be loaded via a module, such as purge-request module 310a and such as purge-request module 120 in FIG. 1 and such as purge-request module 200 in FIG. 2 via GUI 310b, such as GUI 130.

According to some embodiments of the current disclosure, each customer in the loaded file may be inserted to a purge stack 315. The customers may be deleted under GDPR.

According to some embodiments of the current disclosure, a module, such as purge-request module 310a may check for each customer in the purge stack if the customer has a transactional activity 320. If the customer has a transactional activity, the customer may not be flagged for purge 325. If the customer hasn't a transactional activity, checking if the customer is linked to primary accounts 330.

According to some embodiments of the current disclosure, if the customer is linked to primary accounts, then checking purge status of all cascades related parties for each primary account 340, if the customer is not linked to primary accounts, then, the customer may be flagged to be purged 335.

According to some embodiments of the current disclosure, after checking purge status of all cascades related parties for each primary account 340 checking if all customers are flagged for all accounts 345. Once the relations of related parties are marked for purging, all the accounts sharing this relation would also be checked for marking the purging flag.

According to some embodiments of the current disclosure, if all customers are flagged for all accounts, then checking if the customer and the primary accounts have a Suspicious Activity Monitoring (SAM) open alerts 350. If the customer and the primary accounts do not have SAM open alerts then, flagging all primary accounts and the customer to be purged 355.

According to some embodiments of the current disclosure, If the customer and the primary accounts have SAM open alerts then, or all customers are not flagged for all accounts, then accounts [LL-accounts?] and customer may not be flagged to be purged 360.

According to some embodiments of the current disclosure, when the request-purge module 310 has flagged static data/relations related to flagged parties and flagged accounts 365, then all flagged entities and data may be purged 370.

According to some embodiments of the current disclosure, when the request-purge module 310 may have received a selection of SAM closed alerts distributed to flagged customer and accounts 375, then the selected SAM alerts may be purged 380 and an audit entry may be created in the database.

According to some embodiments of the current disclosure, the request-purge module 310 may create a statistics report based on parties in the purge stack 385, for each completed batch process

FIG. 4 is a screenshot of statistics report in pie-chart format 400, in accordance with some embodiments of the present disclosure.

According to some embodiments of the current disclosure, to enable the FI to generate statistic reports in a graphical form with relevant statistical details, of accounts deletion. e.g., under GDPR, by a module such as purge-request module 120 in FIG. 1 and such as purge-request module 200 in FIG. 2, a GUI, such as GUI 130 in FIG. 1 and such as 310b in FIG. 3A may be operated.

FIG. 4 is a screenshot of statistics report in pie-chart format 400, in accordance with some embodiments of the present disclosure.

According to some embodiments of the current disclosure, a pie-chart report, such as pie-chart report 400 of accounts deletion, e.g., under GDPR, by a module, such as purge-request module 120 in FIG. 1 and such as purge-request module 200 in FIG. 2.

According to some embodiments of the current disclosure, audit information may be generated by the purge-request module 120 in FIG. 1 which may record all the details of the customers which have been flagged for purging in the databases. Additionally. the reasoning for the customers which are not purge for a given batch, may be captured.

According to some embodiments of the current disclosure, the pie-chart report 400 may show the number of customers, from the customers for purge that were in the file, has active transactions, associated with Logical Entity (LE) or Party Group (PGR) and how many customers have associated primary account. Portion 410 represent the number of purged accounts, portion 420 represents accounts that have active transactions, portion 430 represents accounts which are associated with LE or PGR group and portion 440 represents accounts that have associated primary accounts.

FIG. 5 is a screenshot of a user interface for purging 500, in accordance with some embodiments of the present disclosure.

According to some embodiments of the current disclosure, element 510 represents check points for a Financial Institution in GUI, such as GUI 130 in FIG. 1 before purging a customer from the databases.

According to some embodiments of the current disclosure, element 520 represents a file upload option in GUI, such as GUI 130 in FIG. 1 for FI.

According to some embodiments of the current disclosure, element 530 represents a tabular display of the uploaded batch details having the batch load date and load status.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions. changes, and equivalents will now occur to those of ordinary skill in the art. It is, therefore, to be understood that the appended claims are intended to cover all such modifications and changes as fall within the true spirit of the disclosure.

What is claimed:

1. A computerized-method for reducing data inconsistency after purging client records, in Financial Institute (FI) databases, when exceeding retention period, the computerized-method comprising:
in a computerized-system comprising: one or more processors, one or more customer-information databases and an application associated thereto, said one or more processors are operating a purge-request module, said purge-request module comprising:
a. receiving a file including one or more customer identifications (ID)s;
b. for each client in the received file:
(i) retrieving references and links from the one or more customer-information databases to populate one or more tables with customer details based on the customer IDs
(ii) presenting a list of one or more conditions via a Graphical User Interface (GUI) of the application to enable a user to select one or more conditions for validation before purging;
(iii) checking each selected condition; and
(iv) when the selected conditions for validation before purging are met marking the client for batch process purging;
c. purging all marked clients via a batch process.

2. The computerized-method of claim 1, wherein the one or more conditions are selected from at least one of: (i) no active transactions; (ii) the client is part of a Logical Entity (LE) or a Party Group (PGR); (iii) active primary account of the client is associated with an active party; (iv) open Suspicious Activity Monitoring (SAM) alert for accounts related to the client; and (v) open SAM alert for the client.

3. The computerized-method of claim 1, wherein the purge-request module further comprising presenting a progress of each batch process.

4. The computerized-method of claim 3, wherein the purge-request module further comprising generating a statistics report for each completed batch process.

5. The computerized-method of claim 4, wherein the statistic report is in tabular format or in pie-chart format.

6. The computerized-method of claim 5, wherein the statistics report in tabular format includes: unique sequence number of the batch process, start timestamp, end timestamp, number of records processed and one or more customers purged.

7. The computerized-method of claim 5, wherein the statistics report in pie-chart format includes: count of related parties, accounts, alerts, number parties purged by the application.

8. The computerized-method of claim 2, wherein the purge-request module further comprising purging related alerts for accounts related to each marked client, when open SAM alert for accounts related to the client condition has been selected.

9. The computerized-method of claim 1, wherein the purge-request module further comprising purging related alerts of each marked client, when open SAM alert for the client condition has been selected.

10. The computerized-method of claim 1, wherein the one or more customer-information databases include at least one of: (i) application database; (ii) landing database; (iii) audit database: (iv) profile database.

11. The computerized-method of claim 1, wherein the purging of all marked clients via the batch process further includes marking the retrieved references and links which are related to all marked clients as not part of detection and alert distribution process of associated Anti Money Laundering (AML) system.
